(19) United States
(12) Patent Application Publication
(10) Pub. No.: US 2008/0261098 A1
(43) Pub. Date: Oct. 23, 2008

(54) PROTON-CONDUCTING MEMBRANES FOR ELECTROCHEMICAL DEVICES, AND RELATED ARTICLES AND PROCESSES

(75) Inventors: John Patrick Lemmon, Schoharie, NY (US); Malgorzata Iwona Rubinsztajn, Ballston Spa, NY (US); Richard Louis Hart, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/737,952

(22) Filed: Apr. 20, 2007

(51) Int. Cl. H01M 8/10; C25B 11/00; H01M 6/18; H01M 8/00

(52) U.S. Cl. 429/33; 204/280; 429/12; 429/304; 429/305; 429/313; 429/314

(57) ABSTRACT

A method for making a proton-conducting membrane is described. The method includes the steps of combining a protonated, layered inorganic material with a proton-conducting organic polymer in a liquid medium; exfoliating the layered inorganic material, so that individual layers of the inorganic material are suspended in the liquid medium and spaced from each other; and the polymer is absorbed onto the surface of the individual layers. In this manner, a polymer-inorganic composite is formed. The liquid can then be removed, to recover the resulting membrane. Related electrolysis and fuel cell devices are also described, which incorporate the proton-conducting membrane.

### BACKGROUND

The present invention generally relates to membranes useful in electrochemical devices and processes. More specifically, some embodiments of the invention relate to proton-conducting membranes which are suitable for electrolyzers and for proton exchange membrane (PEM) fuel cells.

Fuel cells have been the subject of a great deal of research for a number of decades now. Special interest has more recently been placed on PEM fuel cells, in view of the fact that they may be very well-suited for use in automobiles. (The acronym “PEM” can also designate “polymer electrolyte membrane”, which generally refers to the same type of device). Fuel cells electrochemically react a fuel, such as hydrogen, with an oxidant, such as air, to produce electricity and water. In brief, hydrogen fuel is channeled through field flow plates to an anode on one side of the cell, while oxygen from the air is channeled to the cathode on the other side of the cell. At the anode, a catalyst causes the hydrogen to split into positive hydrogen ions (protons) and negatively charged electrons. A polymer electrolyte membrane situated between the cathode and the anode allows only the positively charged ions to pass through it to the cathode. The negatively charged electrons must travel along an external circuit to the cathode, creating electrical current. At the cathode, the electrons and the positively charged hydrogen ions combine with oxygen to form water, which flows out of the cell.

The proton-conducting membrane is critical to the operation of the fuel cell. In general, these membranes must exhibit ionic exchange capacity, proton conductivity, thermal stability, and mechanical stability. They must also exhibit chemical stability—especially electrochemical stability. Specifically, the chemical components should neither be reduced nor oxidized during constant cycling. Moreover, low cost is another important consideration in the selection of a particular membrane.

A number of commercial membranes are available for use in fuel cells. Examples include polytetrafluoroethylene ionomers having sulfonic or carboxylic ionic functional groups, such as the NAFION®, products, available from DuPont Company. Various sulfonated polymers, such as sulfonated poly(ether etherketones) (PEEK), are frequently used as well.

In general, PEM fuel cells used in automobiles operate at low temperatures, e.g., about 80° C.-100° C. In many cases, it would be desirable if the PEM cells could operate at higher temperatures, e.g., about 140° C. to about 350° C. Higher operating temperatures can increase the working efficiency of the fuel cell. However, such temperatures can also degrade the polymer in the membrane more quickly. Furthermore, the membrane, which often requires a moisture-filled environment during use, may have a greater tendency to dry out at these elevated temperatures.

In addition to fuel cells, these types of proton-conducting membranes can be used in other technological applications. For example, they are used in the production of hydrogen by electrolysis. As those skilled in the art understand, the operation of an electrolyzer can be considered to be “electrically reverse” to the operation of a fuel cell. The temperature limitations present when the membranes are used in fuel cells are also present in the case of electrolyzers. Thus, while it would be advantageous and efficient to operate a steam electrolysis system at temperatures above 100° C., the thermally-sensitive conductive membranes effectively prevent such operation.

Moreover, electrolysis systems in the prior art have often been carried out in an alkaline environment, e.g., at a pH of about 14. Such a caustic environment can result in damage to various hardware and connections in an electrolysis bath. The caustic environment can also decrease the over-potential to form oxygen at one of the electrodes.

In view of this discussion, it should be clear that the development of new proton-conducting membranes would be welcome in the art. The membranes should exhibit a thermal stability greater than membranes of the prior art. Moreover, the membranes should exhibit a conductivity which would permit their use in various electrochemical devices, like PEM fuel cells and steam electrolysis systems.

### BRIEF DESCRIPTION OF THE INVENTION

One embodiment of this invention is directed to a method for making a proton-conducting membrane. The method comprises the following steps:

(a) combining a protonated, layered inorganic material with a proton-conducting organic polymer in a liquid medium;

(b) exfoliating the layered inorganic material, so that individual layers of the inorganic material are suspended in the liquid medium and spaced from each other; and the polymer is absorbed onto the surface of the individual layers, forming a polymer-inorganic composite; and then

(c) removing substantially all of the liquid, and forming the polymer-inorganic composite into a membrane.

Another embodiment of the invention is directed to a proton-conducting membrane, comprising a cured polymer matrix in which an inorganic material is dispersed. The inorganic material of the membrane is in the form of exfoliated layers; and polymer chains of the polymer matrix are disposed between the exfoliated layers. The inorganic material usually comprises a hydrous silicate based on at least one element (in addition to silicon) selected from the group consisting of zirconium, titanium, phosphorous, aluminum, and combinations thereof.

An electrolysis device represents another embodiment of the invention. The device comprises two electrodes electrically connected to each other through a power supply. Each electrode is physically separated from the other electrode by way of a proton-conducting membrane. As mentioned above, the proton-conducting membrane comprises a cured polymer matrix in which an inorganic material is dispersed. The inorganic material is in the form of exfoliated layers; wherein polymer chains of the polymer matrix are disposed between the exfoliated layers.

Still another embodiment is directed to a proton exchange membrane (PEM) fuel cell. The PEM cell comprises two electrodes electrically connected to each other through a power supply, wherein the electrodes are separated from each other by a proton-conducting membrane. In this embodiment, the proton-conducting membrane comprises a cured polymer matrix in which an inorganic material is dispersed, said inorganic material being in the form of exfoliated layers. The polymer chains of the polymer matrix are disposed between the exfoliated layers. The inorganic material usually comprises a hydrous silicate based on at least one metal or metalloid selected from the group consisting of silicon, zirconium, titanium, and combinations thereof.

An additional embodiment claimed herein relates to a method for producing hydrogen electrolytically from steam by way of steam electrolysis, comprising the step of directing steam from a steam source to at least the anode of an electrically-powered electrolytic cell, wherein the cell comprises two electrodes electrically connected to each other through a power supply, and the electrodes are separated from each other by the proton-conducting membrane described herein. Electrical activation of the cell causes the electrolytic dissociation of water in the steam, so that hydrogen is generated within the cell.

### BRIEF DESCRIPTION OF THE DRAWINGS

FIG. 1 is a schematic illustration of a polymer-inorganic assembly dispersed in a liquid medium.

FIG. 2 is a schematic illustration of the polymer-inorganic composite of FIG. 1, in exfoliated form.

FIG. 3 is a schematic illustration of the polymer-inorganic composite of FIG. 2, wherein the exfoliated composite has been collapsed.

FIG. 4 illustrates an exemplary electrolysis system in accordance with embodiments of this invention.

### DETAILED DESCRIPTION OF THE INVENTION

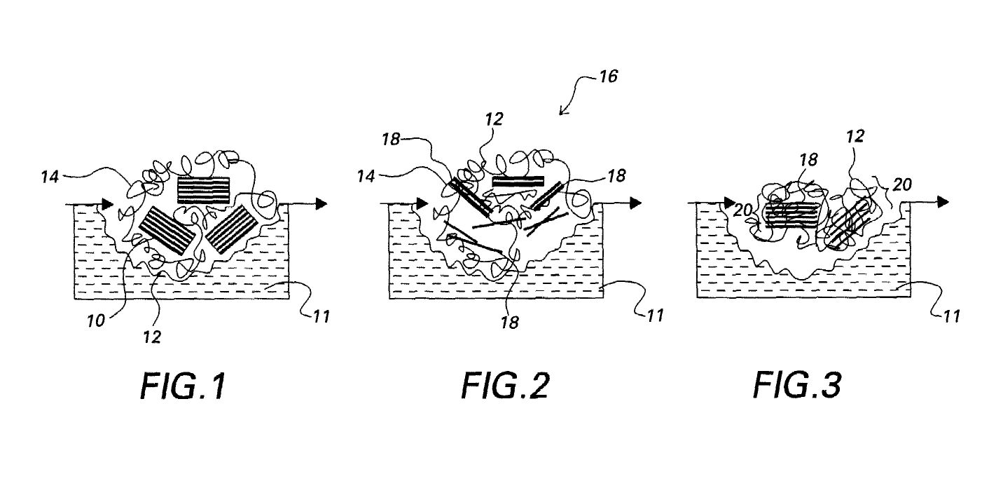

The proton-conducting membrane described herein includes a layered inorganic material. As used herein, the term “layered” generally refers to a material having a multi-layer physical structure, e.g., one having a leaf- or sheet-like structure, such as a laminated phyllosilicate mineral. These materials are well-known in the art, and described, for example, in U.S. Pat. No. 5,840,796 (Badesha et al), which is incorporated herein by reference. FIG. 1 depicts individual layers 10 of a typical inorganic material of this type, prior to exfoliation of the material. The material is suspended in a suitable liquid medium 11, as described below.

Non-limiting examples of the layered inorganic materials include various silicates (e.g., aluminosilicates, zeolites), zirconates, titanates, phosphates, and combinations thereof. An example of a zirconate is barium zirconate. Non-limiting examples of titanates are barium titanate, strontium titanate, calcium titanate, sodium titanate, magnesium titanate, and hydro-titanate (i.e., a protonated titanate).

Very often (but not always), the inorganic material is a hydrous silicate material, based on at least one metal. The metals are typically selected from the group consisting of aluminum, magnesium, sodium, potassium, calcium, lithium, iron, and combinations thereof. Mica and various clays are prominent examples of such materials.

In most embodiments, the inorganic material should be protonated before use. This step replaces substantially all metal or metalloid cations (e.g., sodium, calcium, potassium, magnesium, silicon and aluminum) in the inorganic material with protons, so that the material becomes proton-conducting. In many cases, protonated grades of the inorganic material are commercially available.

As an alternative to using the commercial grades, inorganic materials of this type can be protonated by known techniques. For example, the procedure could be carried out through an ion-exchange process, using an ion exchange resin. The inorganic material, e.g., a clay, could be treated in a proton-based (e.g., hydrogen) acid solution, such as hydrochloric acid. Treatment time and temperature will depend on a variety of factors, such as the type of inorganic material being employed; the form in which it is available, and the acidic treating agents employed. Usually, treatment is carried out at about room temperature to about 80° C. (The temperature should preferably be below the boiling point of the solution in which the reaction is taking place). More typically, the temperature is in the range of about 30° C. to about 50° C. The treatment time is usually in the range of about 4 hours to about 24 hours. Other treatment regimens are possible.

The protonated inorganic material is then combined with a proton-conducting organic polymer 14, in the liquid medium 11 (FIG. 1). Any suitable method of combining the polymer with the inorganic material can be used. As an example, the polymer—typically dissolved or suspended in a solvent—can simply be added to the liquid medium in which the inorganic material is dispersed, followed by mixing and optional sonication (as described below).

A variety of proton-conducting polymers can be used for this purpose, and many are available in the art. Those skilled in this area understand that many polymers can be made to be proton-conducting, e.g., by modification with a variety of surfactants; by grafting ions onto polymer chains (e.g., perfluorosuflonated membranes); or by treatment in a cationic exchange process. In some cases, the proton-conducting polymer is referred to as an “ionomer” or a “polyelectrolyte”.

The proton-conducting polymer should be one which is thermally stable at a temperature of at least about 80° C. In preferred embodiments, the polymer should be thermally stable at a temperature of at least about 100° C., and most preferably, at a temperature of at least about 200° C. Thermal stability can be determined by a number of techniques known in the art. As but one example, the polymer could be soaked or “cooked” in boiling water for about 30 to 60 minutes, and then removed from the water. If the polymer remains substantially flexible, it is deemed to be thermally stable. Conversely, if the polymer is brittle or is degraded and has lost its integrity, it is deemed to be thermally unstable. As another non-limiting measurement, a decrease of greater than about 20% of the molecular weight (weight average) of the polymer after the described water-soak is also usually indicative of thermal instability.

Non-limiting examples of the proton-conducting polymers include aromatic amines; fluorinated silicones; and sulfonated polymers. Some specific examples of the sulfonated polymers are: sulfonated polyether ether ketone (PEEK); sulfonated poly(phenylene ether ether ketone); sulfonated polystyrene; sulfonated polyethylene, sulfonated polyethylene oxide; sulfonated polypropylene oxide; sulfonated polytetramethylene oxide; sulfonated polyetherimides, and various combinations of any of the foregoing. In some instances, polymers may contain alternating blocks of sulfonated groups, so as to improve the agglomeration of the resulting sulfonated domains which extend from the polymer backbone.

Many commercial proton-conducting polymers are available. Non-limiting examples include the Nafion® brand of copolymers, available from DuPont. Many of these materials are based on tetrafluoroethylene/fluorovinylether copolymers, to which sulfonic acid groups are attached. Fluorine-free proton-conducting polymers are also available as well (some of which are mentioned above), e.g., sulfonated polyetherketones, arylketones, and polybenzimidazoles.

Other proton-conducting polymers are described in pending patent applications assigned to the assignee of the present invention. As an example, patent application Ser. No. 11/314,877, filed on Dec. 20, 2005, for David Moore et al, describes sulfonated block copolymers which comprise sulfonated polyarytletherketone blocks and polyethersulfone blocks. As described in the referenced Application, these copolymers may exhibit proton conductivities which make them very suitable for use in fuel cell applications. Methods for preparing the copolymers are also described in application Ser. No. 11/314,877, which is incorporated herein by reference.

Patent application Ser. No. 11/193,552, filed on Jul. 29, 2005, for Hongyi Zhou et al, describes polyethersulfone compositions which may also function as suitable proton-conducting polymers. These compositions often comprise sulfonyl group-containing subunits derived from bis(halophenyl)sulfone. As a non-limiting illustration, the referenced Application describes the copolymerization of 4,4′-dihydroxyphenyl-2,6-pyridine and/or 4,4′-dihydroxy-m-terphenyl and 4,4′-difluoro-3,3′-disodiumsulfonated-phenylsulfone (s-DFDPS) and/or 4,4′-difluorophenylsulfone, carried out in a suitable solvent system such as NMP (N-methylpyrollidone) and toluene. Patent application Ser. No. 11/193,552 is also incorporated herein by reference.

Patent application Ser. No. 11/263,166, filed on Oct. 31, 2005 for Hongyi Zhou et al, describes polyethersulfones and polymer compositions which include at least one inorganic heteropolyacid. In one embodiment, pendant benzimidazole functionalities are attached to a sulfonated polyethersulfone backbone, and the in-situ formation of a heteropolyacid salt by reaction with the benzimidazole-substituted polymer, produces a material useful for a fuel cell membrane. The contents of patent application Ser. No. 11/263,166 are also incorporated herein by reference.

In the case of the sulfonated proton-conducting polymers, the degree to which they are sulfonated will depend on various factors, including the specific polymer being employed; and the degree of cross-linking within the polymer. Another primary factor is the desired level of proton conductivity for the polymer, which is directly related to the degree of sulfonation. In general, the degree of sulfonation should be high enough to provide a desired level of ionic conductivity. However, the degree of sulfonation should be low enough to prevent the polymer from becoming water-soluble—at least in those instances in which the polymer membrane is being used in an aqueous environment. In some embodiments, the degree of sulfonation is at least about 20%, i.e., 20% of the groups in the main polymer chain have been sulfonated. In some more specific embodiments, the degree of sulfonation is greater than about 40%. In preferred embodiments for selected end uses, the degree of sulfonation is greater than about 60%.

The amount of proton-conducting polymer used will depend on a variety of factors. They include, for example: the particular polymer employed; the type and amount of inorganic material employed, as well as its molecular weight and density; the degree of exfoliation desired; and the proton-conducting requirements for the inorganic-polymer system. As a very general, non-limiting example, the amount of proton-conducting polymer can range from about 5% by weight up to about 90% by weight, based on the total weight of polymer and inorganic material. In practice, for the optimization of a given inorganic-polymer system, the proportionate addition of inorganic material is increased until there is an observable loss in relevant properties such as proton conductivity and ductility, e.g., a loss of greater than about 10% in conductivity.

The protonated, inorganic/polymeric material is then exfoliated. Exfoliation causes the individual layers of the material to become fully separated (“delaminated”). The layers also become dispersed, i.e., significantly spaced from each other, within liquid medium 11 (FIG. 2).

Exfoliation techniques are generally known in the art. Non-limiting examples include U.S. Pat. No. 5,840,796 (Badesha et al); U.S. Pat. No. 6,872,230 (Mack et al); and U.S. Pat. No. 7,087,288 (Tsapatsis et al), all of which are incorporated herein by reference. The protonated inorganic material, e.g., a clay, can initially be dispersed in a suitable liquid medium 11 (FIG. 1), such as a liquid colloid. Choice of a suitable liquid medium will depend on various factors, such as the identity of the particular inorganic material; and the type of polymer which will subsequently be incorporated into the liquid, as described below. In some embodiments, the liquid medium comprises a water-miscible, functionalized solvent (e.g., sulfone-functionalized) in which the proton-conducting polymer is soluble. Non-limiting examples of suitable solvents are as follows: sulfonated polyether ketones; dimethyl acetate; dimethyl sulfoxide (DMSO); acetonitrile, and water. Various combinations of any of the foregoing are also possible. The liquid may contain a variety of other additives as well. Non-limiting examples include binders, dispersants; deflocculants, anti-settling agents, swelling agents, pH adjustment agents; and surfactants.

In a typical exfoliation process, the layered inorganic material is agitated in the liquid medium, e.g., the colloid. The agitation causes any particle aggregates which are present to break up; and also causes individual layers of the material to spread apart from each other and become dispersed within the medium. (In many cases, some or all of the individual layers separate into sublayers, as described below). Agitation can be carried out by a variety of techniques. Non-limiting examples include stirring, shaking, sonication, and combinations of any of the foregoing. For higher density materials such as clay, the agitation is sometimes accompanied by some form of shear-force.

Sonication is often the preferred technique to be used for exfoliation. Sonication is well-known in the art, and information can be found in a variety of sources. A non-limiting example is U.S. Pat. No. 6,828,371 (Lee et al), which is incorporated herein by reference. Sonication can be carried out with any device capable of delivering sonic energy according to a desired regimen of frequency ranges and applied energy. Sonicators can be referred to by other names as well, such as ultrasonicators, sonic probes or ultrasonic probes. An example of a suitable device is a 60 Watt ultrasonic processor with a ½″ diameter horn, operating at 20 kHz; commercially available from Sonics and Materials, Inc; Newtown, Conn. Typically, the sound frequency utilized in the present invention will be in the ultrasonic frequency range. However, frequencies near the upper limit of the audible range may also be very suitable.

The operating parameters for sonication will depend on a variety of factors, including the type of inorganic material suspended in the liquid medium; the identity of the liquid medium itself; and the type of sonication equipment. In most (but not all) cases, sonication is carried out at a sound frequency of about 5 kHz to about 10¹⁰ kHz. The operating parameters can also be characterized by the sonic energy applied to the liquid suspension. The energy is typically described by an energy density defined as the amount of energy per gram of liquid suspension. Usually, the energy density is from about 5 kJ/g to about 100 kJ/g. As also described in the patent of Lee et al, the amount of time that a given liquid suspension is sonicated will depend in part on the amount of energy deployed. Those skilled in the art will be able to determine the most appropriate sonication parameters for a given situation.

A typical exfoliated system is depicted (in simplified form) in FIG. 2, in which the layers of inorganic material have generally been separated into individual sublayers or “sheets” 18. The sublayers (which still may themselves contain multiple layers) are spaced from each other and suspended in liquid medium 11. The polymer chains 12 of the proton-conducting polymer 14 form a polymer matrix. The polymer chains generally surround inorganic sublayers 18, forming a polymer-inorganic composite 16, in which the inorganic material is dispersed in the polymer matrix 12. In this manner, the inorganic material, e.g., a clay, can function to protect the polymer from thermal degradation. Moreover, the desired amount of proton conductivity is obtained by way of the conductivity of both the polymer and the protonated inorganic material. Whereas the individual layers in a conventional “non-exfoliated” composite (e.g., clay) are generally parallel to each other, most of the layers of the exfoliated system are not parallel to each other, and may instead be juxtaposed at various angles to each other.

In many embodiments, the polymer-inorganic composite can be referred to as a “nanocomposite”. In such a situation, the organic polymer and the inorganic phase are “organized” on a nanoscale. In other words, the composite includes at least one physical dimension on a nanoscale level. (As used herein, “nanoscale” refers to quantities in the range of about 1 to about 500 nanometers, and more often, no greater than about 100 nanometers). As an example, a nanocomposite formed from an organic polymer and a clay material could comprise clay sublayers or “plates” which have an average thickness less than about 500 nanometers, and preferably, less than about 100 nanometers.

Moreover, in some embodiments, the polymer-inorganic composite suspended in the liquid medium can be “collapsed”, as depicted in FIG. 3. By this technique (sometimes referred to as “self-assembly”), the previously exfoliated inorganic sublayers 18 are again brought into relatively close, substantially parallel contact with each other. Various techniques (or combinations of techniques) can be used to collapse the composite. For example, it can be treated in a centrifuge; or the pH of the liquid medium can be adjusted in a way which will affect the solubility of the inorganic materials.

The distance between layers in the collapsed structure 20 (FIG. 3) is usually much smaller than when the structure is exfoliated. In some embodiments, the average distance between layers (which may be in the form of sublayers, as described above) is in the range of about 10 nm to about 200 nm, and more specifically, in the range of about 10 nm to about 100 nm. However, these ranges can vary considerably. Polymer strands 12 are sandwiched between each layer 18, or between most layers. Moreover, the collapsed structure can be in either crystalline or amorphous form. The collapsed structure is sometimes preferred because it may provide greater thermal stability and improved protonic conductivity.

In some alternative embodiments, the unprotonated inorganic material can be exfoliated prior to the addition of the proton-conducting organic polymer. In this instance, exfoliation in the liquid medium can be carried out as described previously. The organic polymer (unprotonated or already protonated) could then be incorporated into the liquid medium. Protonation of the entire organic-inorganic system can then be carried out as described previously, e.g., via treatment in a proton-based acid solution. (Thus, in this embodiment, an organic polymer which has already been protonated can be protonated to an even greater degree by way of this “system-wide” protonation step). When preparing a proton-conducting material according to this alternative sequence of steps, care should be taken to select a protonating acid which will not adversely affect the polymer material.

The polymer-inorganic composite—in exfoliated form or in collapsed form—can be processed and made into a proton-conducting membrane by a number of techniques. Non-limiting examples include casting, calendering, coating, compounding, extrusion, foaming; and molding. Examples of molding techniques include compression molding, injection molding, blow molding, rotational molding, and transfer molding. Other techniques which can be used include thermoforming, lamination, pultrusion, protrusion, draw reduction, spin-bonding, and melt spinning. Usually (though not always), some or all of the solvents and other volatile materials are initially removed from the liquid medium by evaporation, in air or vacuum.

Casting methods are often utilized to form the membranes described herein. These techniques are well-known in the art, and described in many references. As one example, the polymer-inorganic composite can be cast on a suitable solid surface, e.g., a plate, ring, band, or drum, made of metal, ceramic, or plastic. At least a portion of the volatile content can then be removed by drying in an oven, or drying at ambient temperature. Additional heat treatments can be used to further dry the material, and/or to cure a polymerizable material.

Drying and curing times will depend on many factors, such as the type of liquid vehicle, as well as casting and heating techniques and equipment. Those of ordinary skill in the art will be able to determine the most appropriate heating regimen, as well as determining the most appropriate casting method.

A general, non-limiting illustration can be provided, in the case of a polymer-inorganic composite based on PEEK and a barium zirconate material, suspended in an organic solvent such as n-methylpyrolidone (NMP), tetrahydrofuran (THF), DMSO, and the like. In such a case, heating at about room temperature to about 150° C. for about 1 hour to about 24 hours may be sufficient to remove substantially all of the volatile content. An additional heating regimen may be used to cure the material after it has been cast on a substrate. Again, however, there may be quite a bit of variation in these heating regimens, based on many of the factors described herein. Moreover, in an industrial setting using appropriate industrial equipment, heating may purposefully be carried out at a relatively rapid rate, since such a technique may sometimes prevent significant shrinkage of the membrane material, or prevent entrapment of solvent therein.

The thickness of the membrane which is formed will vary considerably, depending in large part on its intended use. In the case of fuel cell and electrolysis applications, the membrane should usually be as thin as possible, since proton conductivity is a function of membrane thickness. However, the membrane should be thick enough to function as an electrolyte, and as an effective barrier to the passage of negatively charged electrons. Membrane thickness will also depend largely on its composition, e.g., the type of materials which constitute the inorganic and polymeric components. As a non-limiting example in the case of a polymer-inorganic composite based on PEEK and a barium zirconate material, the membrane thickness for a steam electrolysis application (discussed below) will usually be in the range of about 5 microns to about 200 microns. In some specific embodiments, the thickness will be in the range of about 50 microns to about 150 microns. (It should be understood that a membrane could be used in the form of multiple layers, and in that instance, the thickness estimates represent the total of those layers).

The proton-conducting membrane formed by the process described above can be used in a PEM cell. Fuel cells of this type are well-known in the art, as are techniques for assembling all of the components for the fuel cell. Non-limiting examples of instructive references include U.S. Pat. Nos. 5,624,769; 5,863,672; 6,007,933; and 6,403,249, all of which are incorporated herein by reference. As described above, the quality of the polymer electrolyte membrane separating the cathode and the anode is critical to the operation of such a fuel cell. It is believed that processes for some embodiments of this invention will result in the formation of polymer-inorganic nanocomposite membranes which satisfy PEM fuel cell operating requirements. For example, the membranes would have the proton conductivity required for the PEM cell, but would also exhibit greater thermal stability and physical integrity than membranes used previously. As an illustration, the membranes could allow the operation of a PEM cell at temperatures in the range of about 80° C. to about 250° C. These temperatures in turn provide greater electrical-generating efficiency, as compared to PEM cells which operate at less than 80° C. PEM fuel cells are ideally suited for use in home applications, as well as in automotive applications. As those skilled in the art understand, the fuel cells are typically assembled into fuel cell stacks for greater practical utilization.

As also mentioned above, the proton-conducting membranes described herein can be used in the electrolytic production of hydrogen. Water electrolysis systems are also known in the art, and described in a variety of references. Non-limiting examples include U.S. Pat. Nos. 6,939,449 and 6,726,893, which are incorporated herein by reference. Another example is provided in U.S. Patent Publication 2006/0131164 (Soloveichik), which is also incorporated herein by reference

In some preferred embodiments, the proton-conducting membranes are used in steam electrolysis systems. Steam electrolysis (sometimes referred to as “high temperature electrolysis”) is usually a more efficient process than traditional, room-temperature electrolysis, for a number of reasons. For example, in a steam electrolysis process, some of the energy is supplied as heat, which is less costly than electricity. Steam electrolysis can be a very convenient avenue for efficiently using excess steam and heat from various power generation systems. Furthermore, the electrolysis reaction itself is more efficient at higher temperatures, e.g., about 180° C. to about 300° C., as compared to room temperature. It should also be noted that the proton-conducting membrane disclosed herein usually possesses much greater thermal stability and integrity at these operating temperatures, as compared to conventional, organic-type membranes which are typically used in PEM fuel cell applications. Moreover, the membranes are capable of enduring very high steam concentrations. (Those skilled in the art understand that an electrolysis apparatus can be very similar in structure to a fuel cell apparatus, although the processes carried out with each device are different, and are often said to be electrochemically opposite each other. As one example, fuel cells involve the flow of hydrogen or some hydrogen source into the cell itself, e.g., diffusing into the anode electrode. In contrast, electrolysis systems involve the use of an electric current to produce hydrogen. Thus, conventional structural features are varied and adapted for each process).

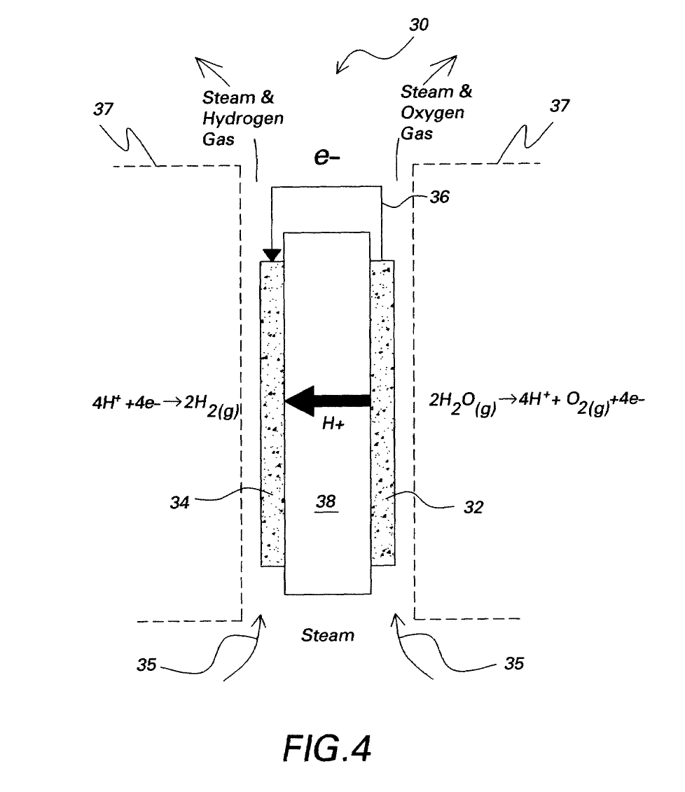

FIG. 4 illustrates a typical steam electrolysis system 30. Device 30 includes two electrodes: anode 32 and cathode 34. (The electrodes are sometimes referred to as “electrocatalysts”). The electrodes typically contain channels or porous regions (not specifically shown), for the passage of steam 35, which originates at any steam source. Steam 35 is directed through a plate structure 37 (e.g., a manifold surrounding the electrolysis cell), so that it comes into direct contact with the porous electrodes. (While steam is shown as being directed toward both anode 32 and cathode 34, its presence is only necessary for the reaction at the anode. However, in some preferred embodiments, steam is also directed through the cathode. In this manner, the cathode, as well as the anode, can remain hydrated).

Electrodes 32 and 34 are electrically connected through an external circuit 36 and a power source (not shown). As those skilled in the art understand, the electrodes are formed of a material capable of conducting an electrical charge and remaining chemically and physically stable. Non-limiting examples of suitable materials for the cathode include nickel, nickel alloys, silver, copper, gold, platinum, palladium rhodium, iridium, cobalt, ruthenium, and combinations thereof. Non-limiting examples of suitable materials for the anode include stainless steel, nickel, or nickel alloys. In some cases, the electrodes can also be formed from alloys which contain carbon or graphite.

The proton-conducting membrane 38, also referred to as a “separator” in this situation, is disposed between anode 32 and cathode 34. Membrane 38—prepared as described previously—prevents mixing of the product gases during the electrolysis process. As mentioned above, the shape and thickness of the membrane will depend on a number of factors related to the specific electrolysis cell being operated. The membrane can be attached to the electrodes by various techniques, e.g., bonding techniques.

The typical cathode reaction which produces hydrogen is shown to the left of cathode 34. The rate of production of hydrogen is proportional to the current density in the electrolysis cell. The typical reaction occurring at the anode is shown to the right of anode 32. In general, the steam electrolysis process is carried out under relative humidity (R.H.) conditions of at least about 50%, for a given operating temperature. In some preferred embodiments, the relative humidity is greater than about 80%, and most preferably, greater than about 90%.

A direct current (DC) is usually passed between the two electrodes. The current splits water (the reactant, here in the form of steam) into hydrogen and oxygen, the component product gases. As protons are transported across membrane 38, hydrogen (or a hydrogen-rich gas) evolves at the surface of cathode 34, and is collected as hydrogen gas. The hydrogen can be collected and transported for further use and storage by any conventional technique, e.g., the use of piping, plates, spacers (e.g., insulating structures), and other manifolds. In similar fashion, as the anode gas phase (steam) adsorbs onto the anode 32, oxygen gas evolves at the anode surface, and is usually released as exhaust. The ability to rapidly produce hydrogen in the continuous gas phase, as compared to the generation of hydrogen bubbles which are eventually collected as gas, is another advantage for a steam electrolysis process.

Those skilled in the art are familiar with other details regarding hydrolysis systems and steam hydrolysis techniques. As one example, the manifold/plate structure 37, shown in simplified form, by dashed lines, can be constructed according to many different designs. Moreover, the electrodes and the proton-conducting membrane are not drawn to scale. Their relative thicknesses can vary considerably, based on many of the factors set forth herein. Furthermore, the overall electrolysis process may also involve purification of the hydrogen-rich gas, to obtain substantially pure hydrogen. Moisture in the hydrogen-rich gas may be removed by various techniques, such as condensation of the moisture; use of a molecular sieve bed, or some combination thereof. Furthermore, those skilled in the art understand that a plurality of electrolysis systems like that shown in FIG. 4 can be connected in series or parallel, to achieve a selected level of hydrogen production output.

As noted above, embodiments of the present invention are believed to result in polymer-inorganic membranes which are thermally stable at above about 180° C., and which have the conductivity required for end uses like steam electrolysis. In contrast, membranes formed from conventional protonated materials like the perfluorinated sulfonated polymers (without an inorganic constituent) typically break down at temperatures which exceed about 120° C.

As in the case of fuel cell processes, the ability to carry out electrolysis at about 140° C. to about 350° C. can be very advantageous in many circumstances. As a non-limiting example, the process can operate more efficiently and economically because steam or waste heat from various power generation sources can rapidly bring the electrolyzer up to proper operating temperatures. Thus, the cost of external heating is minimized or eliminated. As an illustration, clean steam which is discharged from a nuclear power plant can be used to bring an electrolyzer up to operating temperature, e.g., through the use of heat exchangers. Moreover, waste heat from the nuclear plant could be used to boil water, thereby producing more steam for an electrolyzer system. In similar fashion, steam which originates from a geothermal source (and which is often found at the temperature ranges described herein) can also be utilized as part of an electrolyzer system. Such systems can provide hydrogen as an end-product, or can use or store the hydrogen for other purposes, e.g., hydrogenation.

Furthermore, in addition to the ability to produce hydrogen at higher temperatures, the present invention avoids the need for carrying out hydrolysis in a very corrosive environment. As described previously, alkaline hydrolysis in the past has been carried out with electrolytes like potassium hydroxide, at a pH of about 14. Such a caustic environment can result in damage to various fittings and connections in an electrolysis bath, while also decreasing the over-potential to form oxygen at one of the electrodes. In contrast, the ability to run the electrolysis reaction at higher temperatures in relatively pure water can increase efficiency, while also minimizing wear-and-tear on the process hardware.

Various embodiments of this invention have been described in rather full detail. However, it should be understood that such detail need not be strictly adhered to, and that various changes and modifications may suggest themselves to one skilled in the art, all falling within the scope of the invention as defined by the appended claims.

What is claimed:

1. A method for making a proton-conducting membrane, comprising the following steps:
(a) combining a protonated, layered inorganic material with a proton-conducting organic polymer in a liquid medium;
(b) exfoliating the layered inorganic material, so that layers of the inorganic material are suspended in the liquid medium and spaced from each other; and the polymer is absorbed onto the surface of the layers, forming a polymer-inorganic composite; and then
(c) removing substantially all of the liquid, and forming the polymer-inorganic composite into a membrane.

2. The method of claim 1, wherein the inorganic material is protonated, prior to step (a), by an ion exchange technique.

3. The method of claim 2, wherein the ion exchange technique comprises contacting the inorganic material with an acidic, hydrogen-containing material, under heat treatment conditions which cause hydrogen protons to replace substantially all metal cations which may be present in the inorganic material.

4. The method of claim 1, wherein exfoliation of the layered inorganic material is carried out by a technique comprising agitation of the liquid medium, so that at least some of the layers of the inorganic material spread apart from each other and become dispersed within the liquid medium.

5. The method of claim 4, wherein agitation of the liquid medium causes at least some of the layers of the inorganic material to separate into sublayers.

6. The method of claim 4, wherein agitation of the liquid medium is carried out by a sonication technique.

7. The method of claim 1, wherein the liquid medium is a colloid.

8. The method of claim 4, wherein the liquid in the liquid medium comprises a water-miscible, functionalized solvent in which the proton-conducting polymer is soluble.

9. The method of claim 8, wherein the solvent is functionalized by sulfone groups.

10. The method of claim 8, wherein the solvent is selected from the group consisting of sulfonated polyether ketones; dimethyl acetonate; dimethyl acetate; dimethyl sulfoxide (DMSO); acetonitrile, water; and combinations of any of the foregoing.

11. The method of claim 1, wherein the inorganic material is selected from the group consisting of silicates, zirconates, titanates, phosphates, and combinations thereof.

12. The method of claim 11, wherein the inorganic material is a hydrous silicate based on at least one metal selected from the group consisting of aluminum, magnesium, sodium, potassium, calcium, lithium, iron, and combinations thereof.

13. The method of claim 12, wherein the hydrous silicate comprises clay.

14. The method of claim 11, wherein the zirconate comprises barium zirconate.

15. The method of claim 11, wherein the titanate is selected from the group consisting of barium titanate, strontium titanate, calcium titanate, sodium titanate, magnesium titanate, hydro-titanate, and combinations thereof.

16. The method of claim 1, wherein the proton-conducting polymer is combined with the inorganic material by mixing within the liquid medium.

17. The method of claim 1, wherein the proton-conducting polymer is thermally stable at a temperature of at least about 80° C.

18. The method of claim 16, wherein the proton-conducting polymer is selected from the group consisting of aromatic amines; fluorinated silicones; and sulfonated polymers.

19. The method of claim 18, wherein the sulfonated polymer is selected from the group consisting of sulfonated poly(phenylene ether ether ketone); sulfonated polystyrene; sulfonated polyethylene, sulfonated polyethylene oxide; sulfonated polypropylene oxide; sulfonated polytetramethylene oxide; sulfonated polyetherimides; and combinations thereof.

20. The method of claim 1, wherein at least one dimension of the exfoliated inorganic layers is on a nanoscale.

21. The method of claim 20, wherein substantially all of the exfoliated inorganic layers have an average thickness of less than about 500 nm.

22. The method of claim 1, wherein the layered inorganic material and the polymer are collapsed after exfoliation in step (b), so that the inorganic layers are brought into relatively close, substantially parallel contact with each other; and at least a portion of the polymer is sandwiched between individual inorganic layers.

23. The method of claim 22, wherein the inorganic material and the polymer are collapsed by a technique selected from the group consisting of centrifuging or pH adjustment, or a combination of centrifuging and pH adjustment.

24. The method of claim 1, wherein the layered inorganic material is exfoliated, prior to being combined with the proton-conducting organic polymer.

25. A proton-conducting membrane, comprising a cured polymer matrix in which an inorganic material is dispersed, wherein the inorganic material is in the form of exfoliated layers; and polymer chains of the polymer matrix are disposed between the exfoliated layers; and
wherein the inorganic material comprises a hydrous silicate material.

26. The proton-conducting membrane of claim 25, wherein the hydrous silicate material is based on at least one element selected from the group consisting of zirconium, titanium, phosphorous, aluminum, and combinations thereof.

27. The proton-conducting membrane of claim 26, wherein the hydrous silicate comprises a clay material.

28. The proton-conducting membrane of claim 25, wherein the polymer matrix comprises a proton-conducting polymer.

29. The proton-conducting membrane of claim 28, wherein the proton-conducting polymer is selected from the group consisting of aromatic amines; fluorinated silicones; and sulfonated polymers.

30. An electrolysis device, comprising two electrodes electrically connected to each other through a power supply, wherein each electrode is physically separated from the other electrode by way of a proton-conducting membrane, and
wherein the proton-conducting membrane comprises a cured polymer matrix in which an inorganic material is dispersed, said inorganic material being in the form of exfoliated layers; wherein polymer chains of the polymer matrix are disposed between the exfoliated layers.

31. A steam electrolysis device according to claim 30.

32. The steam electrolysis device of claim 31, wherein the membrane comprises a nanocomposite material.

33. A proton exchange membrane (PEM) fuel cell, comprising two electrodes electrically connected to each other through a power supply, wherein the electrodes are separated from each other by a proton-conducting membrane, and
wherein the proton-conducting membrane comprises a cured polymer matrix in which an inorganic material is dispersed, said inorganic material being in the form of exfoliated layers; and polymer chains of the polymer matrix are disposed between the exfoliated layers; and
wherein the inorganic material comprises a hydrous silicate based on at least one element selected from the group consisting of zirconium, titanium, phosphorous, aluminum, and combinations thereof.

34. A method for producing hydrogen electrolytically from steam by way of steam electrolysis, comprising the step of directing steam from a steam source to at least the anode of an electrically-powered electrolytic cell, wherein the cell comprises two electrodes electrically connected to each other through a power supply; and the electrodes are separated from each other by a proton-conducting membrane which comprises a cured polymer matrix in which an inorganic material is dispersed, said inorganic material being in the form of exfoliated layers; and wherein polymer chains of the polymer matrix are disposed between the exfoliated layers;
wherein electrical activation of the cell causes the electrolytic dissociation of water in the steam, so that hydrogen is generated within the cell.

35. The method of claim 34, wherein the cured polymer comprises a material selected form the group consisting of aromatic amines; fluorinated silicone;
and sulfonated polymers; and the inorganic material comprises a hydrous silicate.

36. The method of claim 34, wherein the steam electrolysis is carried out at a temperature in the range of about 180° C. to about 300° C.

37. The method of claim 34, wherein the steam source comprises (A) steam discharges from a nuclear power plant or (B) steam emissions from a geothermal source.
